(19) United States
(12) Patent Application Publication
(10) Pub. No.: US 2010/0058631 A1
(43) Pub. Date: Mar. 11, 2010

(54) ATTENTION-ATTRACTING DEVICE

(76) Inventor: Atsushi OONISHI, Inagi-shi (JP)

Correspondence Address: BIRCH STEWART KOLASCH & BIRCH, PO BOX 747, FALLS CHURCH, VA, 22040-0747, US

(21) Appl. No.: 12/302,333

(22) PCT Filed: Jun. 7, 2007
(86) PCT No.: PCT/JP2007/061537

§ 371 Date: Nov. 25, 2008

(30) Foreign Application Priority Data
Jun. 9, 2006 (JP) 2006-160544

(51) Int. Cl. G09F 13/04; G09F 15/00; G09F 19/00; G09F 13/00; G09F 13/16

(52) U.S. Cl. 40/582; 40/607.03; 40/541

(57) ABSTRACT

An attention-attracting device arranged such that strength can be secured against an external force and a light source can be installed at the upper, middle or lower portion in an envelope where characters, pictures, or the like, are displayed in order to attract attention. The attention-attracting device includes a stand (10) equipped with an air blower (70), one or a plurality of telescopic poles (20) standing on the stand (10), an envelope (30) attached to the stand (10) and covering the telescopic poles (20), a frame (40) attached to the telescopic pole (20) and inside of the envelope (30), and a lamp (50) attached to the frame (40) (or to the middle position of the telescopic pole or the upper portion of the stand), the lamp (50) being connected electrically with an electronic ballast (11).

### PRIORITY CLAIM

The present application is based on and claims the priority benefit of Japanese Patent Application 2006-160544 filed on Jun. 9, 2006, the contents of which are incorporated herein by reference in its entirety.

### BACKGROUND OF THE INVENTION

1. Field of the Invention

The present invention relates to an attention-attracting device used in a commercial stand or the like.

2. Description of the Related Art

There has been known a device having a light source inside which is disposed in front of a shop as a commercial stand. This type of the commercial stand sometimes has promotional commercials printed on an envelope made of cloth, plastic film or the like.

There has been known a spotlight projector used in a construction site or the like as night illumination in Japanese Patent Laid-open No. 2005-150123, as a related art to the present invention. A balloon disposed at an upper end of a telescopic pole of the spotlight projector is provided internally with an illumination unit.

However, the conventional commercial stand with an envelope outside is easy to be turned down by strong winds or the like. Further, in the case where the cylindrical long balloon is swollen by blowing air inside, it is difficult for the conventional commercial stand to stand by itself. Furthermore, in the case where the air in the balloon is released so as to be stored, the direction to which the balloon will fall cannot be predicted, thereby, causing a possible danger to the surroundings.

### SUMMARY OF THE INVENTION

The present invention has been accomplished in view of the aforementioned problems, and it is therefore an objective of the present invention to provide an attention-attracting device in which a telescopic pole is installed in the balloon, enabling secured strength to external forces and easy set and storage; and one or a plurality of illuminating lamps are installed in the balloon, enabling easy view of characters and/or pictures provided on an envelope.

To attain the objectives described above, the attention-attracting device according to the present invention includes a stand equipped with an air blower; one or a plurality of telescopic poles standing on the stand; an envelope attached to the stand and covering the telescopic poles; and a frame attached to the telescopic poles and to the inside of the envelope.

Further, it is desirable that one or a plurality of lamps is installed in the envelope, particularly, in the frame or the stand inside the envelope. In this instance, it is desirable that a reflection plate is provided at an upper portion or a lower portion, or both the upper and lower portions.

Furthermore, it is desirable that the stand and the envelope are attached together by a lower fastener-typed connection means, and the frame and the envelope are attached together by an upper fastener-typed connection means.

It is desirable that the envelope is made of cloth or plastic film and is provided with a character and/or a picture.

Moreover, a variation of the attention-attracting device according to the present invention includes one or a plurality of lamps attached to a middle frame which is provided in the middle of the plurality of telescopic poles.

According to the attention-attracting device of the present invention with the above-mentioned configurations, since the strength thereof with respect to an external force is secured by providing in the envelope the telescopic pole which is leveled up and down by the pressure of air blown into the envelope, the envelope can be prevented from falling down even when the external force is exerted thereon by strong winds. Further, while the envelope is expanded by the pressure of air from an air blower, the telescopic pole provided inside the envelope is extended to rise, ensuring a smooth expansion of the envelope.

Furthermore, when the operation of the air blower is stopped, the pressure of air inside the envelope is gradually decreased, meanwhile the upper structures such as the frame and the like is lowered down. Since the air is released at a relatively small amount, the lowering-down speed can be restrained so as to reach the storage state safely.

The lamp is provided at the upper, middle or lower portion of the telescopic pole, by using the reflection plate, lights can be reflected to the lower portion of the envelope efficiently, the displayed characters and/or pictures can be read easily, improving the reminding effect.

The lamp, namely the light source, is covered by the semi-translucent envelope which is made of cloth or plastic film, the glare thereof when viewed from outside can be reduced, and lights can be dispersed to the entire area of the envelope as well.

Additionally, the falling of the attention-attracting device due to winds or the like can be further prevented by providing a plurality of the telescopic poles therein.

### BRIEF DESCRIPTION OF THE DRAWINGS

FIG. 1 is a cross-sectional view of an attention-attracting device according to an embodiment of the present invention.

FIG. 2 is an exploded perspective view of the attention-attracting device illustrated in FIG. 1.

FIG. 3 is an exploded perspective view of the attention-attracting device according to an embodiment of the present invention in which 4 telescopic poles are provided.

FIG. 4 is a cross-sectional view of the attention-attracting device according to an embodiment of the present invention in which 4 telescopic poles are provided and a lamp is attached to an upper portion of an envelope.

FIG. 5 is a cross-sectional view of the attention-attracting device according to an embodiment of the present invention in which 4 telescopic poles are provided and the lamp is attached to a middle portion of the envelope.

FIG. 6 is a cross-sectional view of the attention-attracting device according to an embodiment of the present invention in which 4 telescopic poles are provided and the lamp is attached to a lower portion of the envelope.

### DETAILED DESCRIPTION OF THE PREFERRED EMBODIMENTS

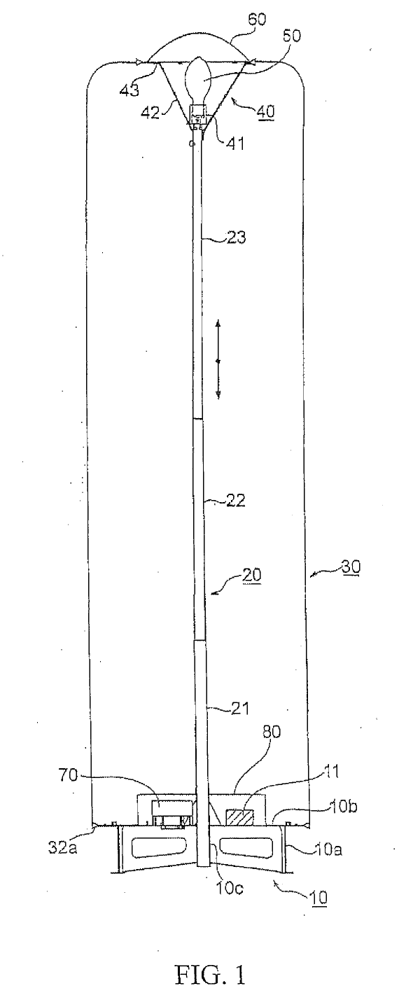

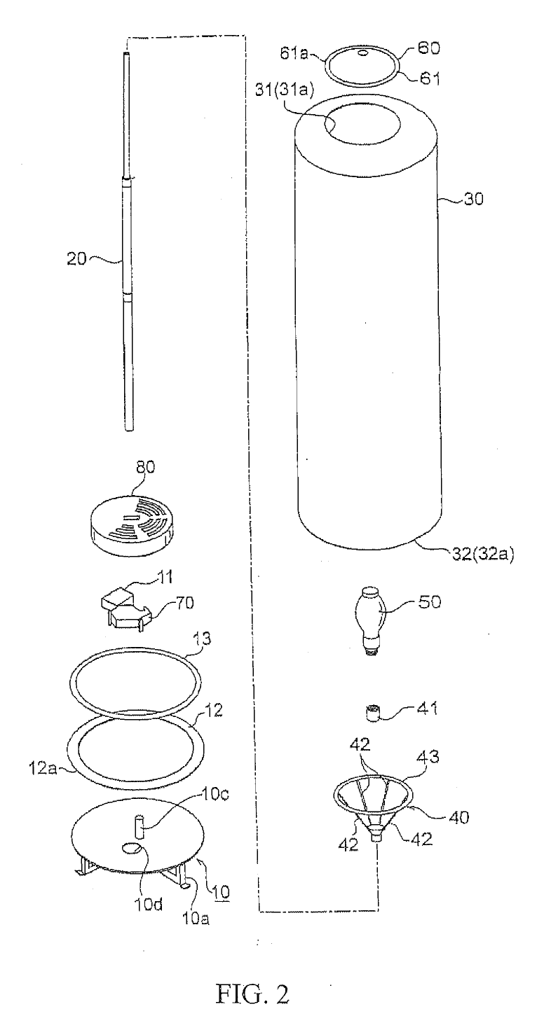

Hereinafter, embodiments of the present invention will be described in detail with reference to the drawings. FIG. 1 is a cross-sectional view of an attention-attracting device according to an embodiment of the present invention. FIG. 2 is an exploded perspective view of the attention-attracting device illustrated in FIG. 1.

As illustrated in FIG. 1, a reference numeral 10 denotes a stand on which an electronic ballast 11 is mounted. The stand includes a bottom portion 10a, a table portion 10b and a cylindrical portion 10c for inserting therein a pole. The electronic ballast 11 is attached on the table portion 10b.

In the cylindrical portion 100, there is erected a telescopic pole 20. The telescopic pole 20 consists of a lower pole 21 inserted into the cylindrical portion 10c, a middle pole 22 slidably inserted into the lower pole 21, and an upper pole 23 slidably inserted into the middle pole 22. The middle pole 22 and the upper pole 23 can be extended and retracted by sliding mutually. The middle pole is configured as one in the present embodiment; it is acceptable to configure the middle pole as a plurality of poles according to the height of the attention-attracting device.

The stand 10 is attached with an envelope 30 which covers the telescopic pole 20 by a lower fastener-typed connection means to be described below. The envelope 30 is made of cloth or a plastic film or the like having flexibility. It is desirable for the envelope 30 to be configured suitable for the attention-attracting device used in a commercial stand by printing thereon characters and pictures which attract attention, sticking thereon a seal with characters and pictures provided for attracting attention, covering thereon a cover with characters and pictures provided for attracting attention, or binding thereon a belt with characters and pictures provided for attracting attention.

Hereinafter, the lower fastener-typed connection means which connects the stand 10 and the envelope 30 will be described. The lower fastener-typed connection means consists of a circular row of teeth 12a consisting of one part of a pair of male and female teeth in a fastener formed at the peripheral portion of a lower circular sheet 12, and a circular row of teeth 32a consisting of the other part of male and female teeth in the fastener formed along an inner peripheral edge 32 of a lower circular opening of the envelope 30.

The lower circular sheet 12 is sandwiched by the stand 10 and a ring 13 and is screwed to the stand 10 together with the ring 13.

In addition to the approximately cylindrical shape as illustrated in the drawings, it is acceptable to form the envelope 30 into various shapes such as a shape of an approximately conical frustum or a reversed conical frustum, a human shape, an animal shape, a building's shape, a cartoon character's shape, or the like.

The upper portion of the telescopic pole 20, in other words, the upper portion of the upper pole 23 is attached with a frame 40. The frame 40 consists of a lamp holder 41 attached to a hub, plural spokes 42 extended from the hub to form a conical frustum shape, and a ring 43 located at the bottom surface of the conical frustum.

The lamp holder 41 is installed with a lamp 50 as a light source of the attention-attracting device for attracting attention. The lamp 50 is electrically connected with the electronic ballast 11. Although a cable connecting the lamp holder and the electronic ballast 11 is not illustrated in the drawings, the cable may be wired inside the telescopic pole 20, or may be wired by fastening outside the telescopic pole 20, for example, on the upper portion of the middle pole 22 or the lower pole 21, or the like.

The frame 40 and a bowl-shaped reflection plate 60 attached to the outside of the upper portion of the envelope 30 are attached to the envelope 30 via a lower fastener-typed connection means or the like to be described below. The upper portion of the envelope 30 is formed with a circular opening 31. The reflection plate 61 is attached so as to cover the circular opening 31.

Hereinafter, descriptions will be given to the upper fastener-typed connection means which connects the frame 40 with the envelope 30. The upper fastener-typed connection means consists of a circular row of teeth 61a consisting of one part of a pair of male and female teeth in a fastener formed at the peripheral portion of an upper circular sheet 61, and a circular row of teeth 31a consisting of the other part of male and female teeth in the fastener formed along the inner peripheral edge of an upper circular opening 31 of the envelope 30.

The upper circular sheet 61 is sandwiched by the reflection plate 60 and the ring 43 of the frame 40 and is screwed to the ring 43 together with the reflection plate 60.

An air hole 10d is formed in the table 10b of the stand 10. To the air hole 10d, a blower 70 for swelling the envelope 30 is attached. The electronic ballast 11 and the blower 70 are covered by a circular cover 80 having a slit enabling air release. It is desirable that the blower 70 is a fan-typed mini-blower.

When the blower 70 is actuated to swell the envelope 30, the telescopic pole 20 is extended by the air pressure to raise the frame 40. When the envelope 30 is completely swollen, the height or position of the frame 40 is maintained. While the blower 70 is stopped, the frame 40 is descended by its deadweight.

The telescopic pole 20 functions as a guide to the ascending and descending of the frame 40. If the telescopic pole 20 were not provided, when the blower 70 is stopped and the frame is descended, it is hard to know which direction the frame 40 will fall to, therefore, it is difficult for one person to cope with it, and it is also easy for the lamp 50 to be damaged.

In addition, in the case where the envelope 30 is replaced by a new one, first, set the envelope 30 to the storing state, open the upper and lower fasteners of the envelope 30, and take out the old envelope 30 from the frame 40 and the stand 10.

Then, cover the new envelope on the frame 40 and the stand 10, match the upper and lower fasteners of the new envelope with the respective fasteners attached to the frame 40 and the stand 10 and fasten the fasteners. Note that the aforementioned fastener-typed connection means is not limited as the engaging means; it is possible to use various engaging means having a male member and a female member which can engage with each other or released from each other freely, such as hooks, snaps, buttons or the like.

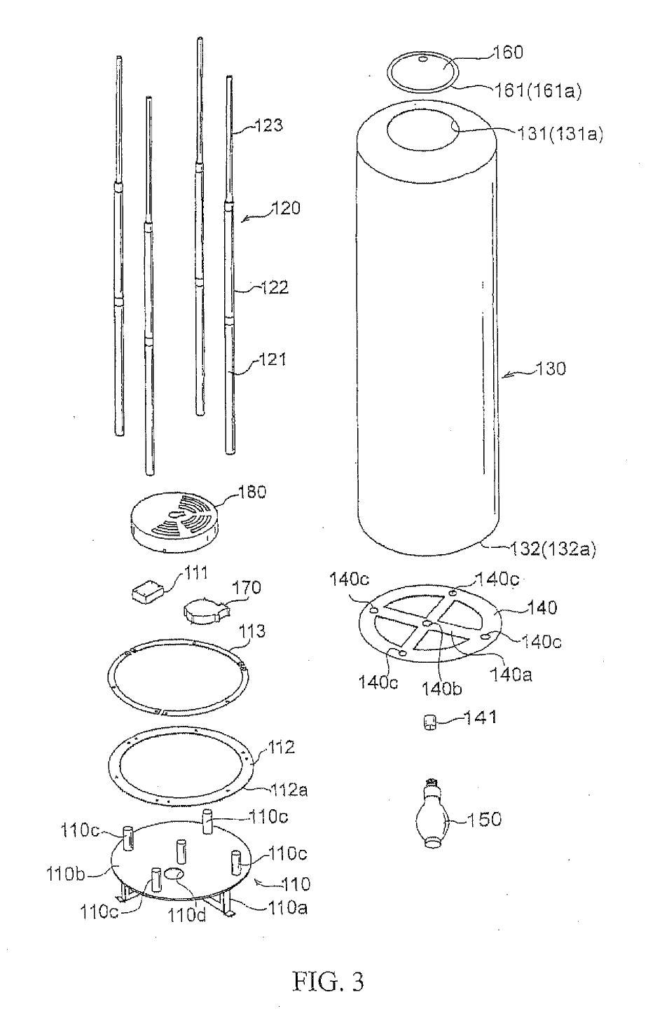

In the above-mentioned embodiment, the telescopic pole is only one. However, if the envelope is large-sized (long in the vertical direction), plural poles can prevent the attention-attracting device from being turned down by winds or the like better than one pole. In this case, the telescopic pole may be 2, 3 or even more. As one example, an embodiment where the number of the telescopic poles is 4 will be given below with reference to FIG. 3.

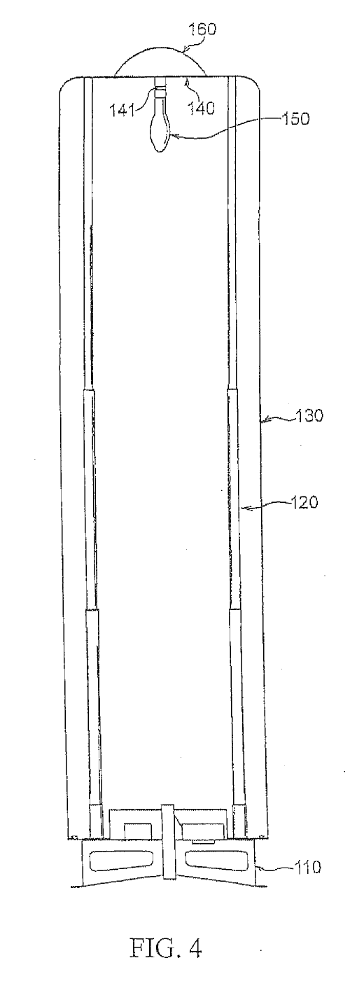

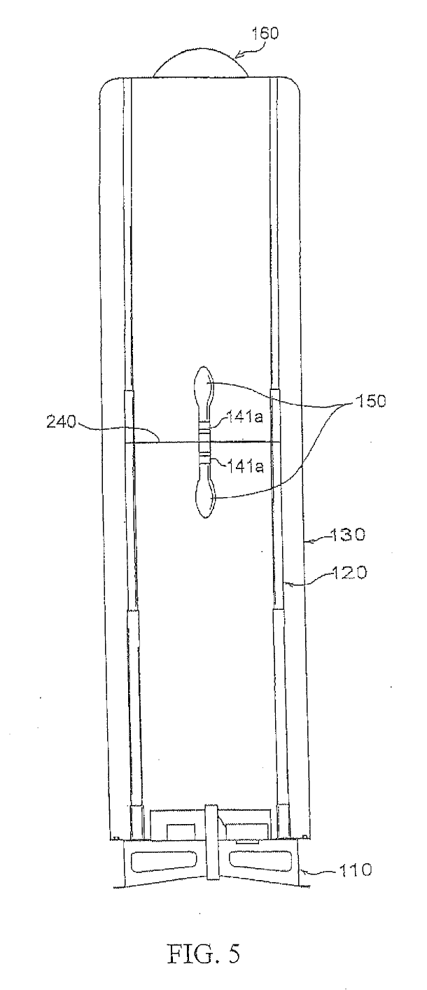

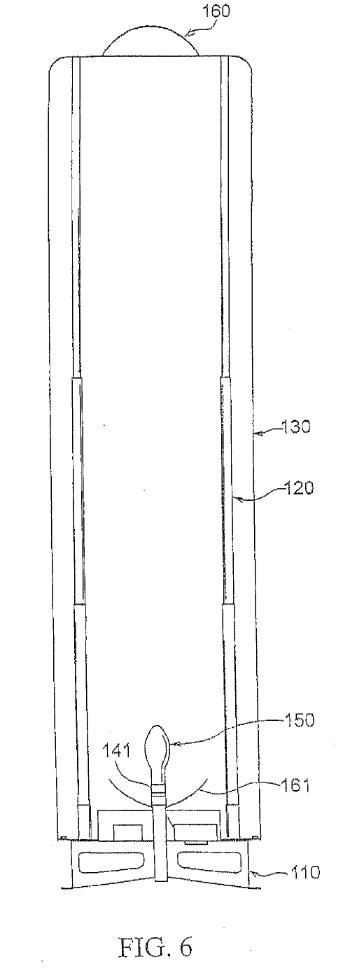

FIG. 3 is an exploded perspective view of the attention-attracting device according to an embodiment of the present invention in which 4 telescopic poles are provided. FIG. 4 is a cross-sectional view of the attention-attracting device according to an embodiment of the present invention in which 4 telescopic poles are provided and the lamp is attached to the upper portion of the envelope. FIG. 5 is a cross-sectional view of the attention-attracting device according to an embodiment of the present invention in which 4 telescopic poles are provided and the lamp is attached to the middle portion of the envelope. FIG. 6 is a cross-sectional view of the attention-attracting device according to an embodiment of the present invention in which 4 telescopic poles are provided and the lamp is attached to the lower portion of the envelope.

As illustrated in FIG. 3, a reference number 110 denotes a stand on which an electronic ballast 111 is mounted. The stand 110 includes a bottom portion 110a, a table portion 110b and four cylindrical portions 110c for inserting therein the poles respectively. The electronic ballast 111 is attached on the table portion 110b.

In each of the cylindrical portions 110c, there is erected a telescopic pole 120. The telescopic pole 120 consists of a lower pole 121 inserted into the cylindrical portion 110c, a middle pole 122 slidably inserted into the lower pole 121, and an upper pole 123 slidably inserted into the middle pole 122. The middle pole 122 and the upper pole 123 can be extended and retracted by sliding, mutually.

The stand 110 is attached with an envelope 130 which covers the telescopic pole 120 by a lower fastener-typed connection means to be described below. The envelope 130 is made of cloth or a plastic film or the like having flexibility. It is desirable for the envelope 130 to be configured suitable for the attention-attracting device used in a commercial stand by printing thereon characters and pictures which attract attention, sticking thereon a seal with characters and pictures provided for attracting attention, covering thereon a cover with characters and pictures provided for attracting attention, or binding thereon a belt with characters and pictures provided for attracting attention.

Hereinafter, the lower fastener-typed connection means which connects the stand 110 and the envelope 130 will be described. The lower fastener-typed connection means consists of a circular row of teeth 112a consisting of one part of a pair of male and female teeth in a fastener formed at the peripheral portion of a lower circular sheet 112, and a circular row of teeth 132a consisting of the other part of male and female teeth in the fastener formed along an inner peripheral edge 132 of a lower circular opening of the envelope 130.

The lower circular sheet 112 is sandwiched by the stand 110 and a ring 113 and is screwed to the stand 110 together with the ring 113.

In addition to the approximately cylindrical shape as illustrated in the drawings, it is acceptable to form the envelope 130 into various shapes such as a shape of an approximately conical frustum or a reversed conical frustum, a human shape, an animal shape, a building's shape, a cartoon character's shape, or the like.

An upper portion of each of the four telescopic poles 120, in other words, the upper portion of the upper pole 123 is attached with a circular frame 140. The frame 140 is provided inside with reinforcing ribs 140a which are crossed at the center to form a central crossed portion 140b. The central crossed portion 140b is attached with a lamp holder 141 for holding a lamp 150. The circular portion of the circular frame 140 is disposed with a hole 140 into which the upper end of the telescopic pole is inserted and attached.

The lamp holder 141 is installed with the lamp 150 as a light source for attracting attention. The lamp 150 is electrically connected with the electronic ballast 111. Although a cable connecting the lamp holder and the electronic ballast 11 is not illustrated in the drawings, the cable may be wired inside the telescopic pole 120, or may be wired by fastening outside the telescopic pole 120, for example, on the upper portion of the middle pole 122 or the lower pole 121, or the like.

The frame 140 and a bowl-shaped reflection plate 160 attached to the outside of the upper portion of the envelope 130 are attached to the envelope 130 via a lower fastener-typed connection means or the like to be described below. The upper portion of the envelope 130 is formed with a circular opening 131. The reflection plate 161 is attached so as to cover the circular opening 131.

Hereinafter, descriptions will be given to an upper fastener-typed connection means which connects the frame 140 with the envelope 130. The upper fastener-typed connection means consists of a circular row of teeth 161a consisting of one part of a pair of male and female teeth in a fastener formed at the peripheral portion of an upper circular sheet 161, and a circular row of teeth 131a consisting of the other part of male and female teeth in the fastener formed along the inner peripheral edge of an upper circular opening 131 of the envelope 130.

The upper circular sheet 161 is sandwiched by the reflection plate 160 and the circular frame 140 and is screwed to the circular frame 140 together with the reflection plate 160.

An air hole 110d is formed in the table 110b of the stand 110. To the air hole 110d, a blower 170 for swelling the envelope 130 is attached. The electronic ballast 111 and the blower 170 are covered by a circular cover 180 having a slit enabling air release. It is desirable that the blower 170 is a fan-typed mini-blower.

When the blower 170 is actuated to swell the envelope 130, the telescopic pole 120 is extended by the air pressure to raise the frame 140. When the envelope 130 is completely swollen, the height or position of the frame 140 is maintained. While the blower 170 is stopped, the frame 140 is descended by its deadweight.

The four telescopic poles 120 function as a guide to the ascending and descending of the frame 140.

In addition, in the case where the envelope 130 is replaced by a new one, first, set the envelope 130 to the storing state, open the upper and lower fasteners of the envelope 130, and take out the old envelope 130 from the frame 140 and the stand 110.

Then cover the new envelope on the frame 140 and the stand 110, match the upper and lower fasteners of the new envelope with the respective fasteners attached to the frame 140 and the stand 110 and fasten the fasteners. Note that the aforementioned fastener-typed connection means is not limited as the engaging means; it is possible to use various engaging means having a male member and a female member which can engage with each other or released from each other freely, such as hooks, snaps, buttons or the like.

FIG. 4 shows an example of the attention-attracting device having 4 telescopic poles 120 and the lamp 150 being attached to the upper portion. The lamp 150 is attached to the lamp holder 141 attached to the circular frame 140.

FIG. 5 shows an example of the attention-attracting device having 4 telescopic poles 120 and the lamp 150 being attached to a middle frame 240 installed at a middle position of the telescopic pole 120. Similar to the frame 140, the middle frame 240 is provided inside with reinforcing ribs crossed at the center to form a central crossed portion. The upper and lower surfaces of the central crossed portion are provided with a lamp holder 141a and a lamp holder 141b, respectively, for holding two lamps 150. Although not shown in the drawings, the circular portion of the middle frame 240 is provided with an inserting hole for the telescopic pole 120. The telescopic pole 120 is attached by being inserted to the inserting hole.

FIG. 6 shows an example of the attention-attracting device having 4 telescopic poles 120 and the lamp 150 being installed on the stand 110. In this case, the lamp 150 is installed to the lamp holder 141 provided in the center of the stand. The light from the lamp 150 is reflected by the reflection plate 161 attached to the table 110b of the stand 110, providing easier view of the characters and/or pictures provided on the envelope 130.

Regarding the attention-attracting device illustrated in FIG. 4, FIG. 5 and FIG. 6, although there is one lamp disposed in the upper position in FIG. 4, two lamps disposed vertically in the middle position in FIG. 5, and one lamp disposed in the lower position in FIG. 6, it is not limited thereto. The number of the lamps may be altered, and the lamps may be installed in both of the upper and middle positions, or both of the upper and lower positions, so as to attract attention better.

Although the present invention has been explained in relation to the preferred embodiments and drawings but not limited, it should be noted that other possible modifications and variations made without departing from the gist and scope of the invention will be comprised in the present invention. Therefore, the appended claims encompass all such changes and modifications as falling within the gist and scope of the present invention.

What is claimed is:

1. An attention-attracting device, comprising:
a stand equipped with an air blower;
one or a plurality of telescopic poles standing on the stand;
an envelope attached to the stand and covering the telescopic poles; and
a frame attached to the telescopic poles and to the inside of the envelope.

2. The attention-attracting device according to claim 1 further includes one or a plurality of lamps attached inside the envelope.

3. The attention-attracting device according to claim 1 further includes one or a plurality of lamps attached to the frame or the stand.

4. The attention-attracting device according to claim 1, wherein an upper portion or a lower portion of the envelope is provided with a reflection plate.

5. The attention-attracting device according to claim 1, wherein the stand and the envelope are attached together by a lower fastener-typed connection means, and the frame and the envelope are attached together by an upper fastener-typed connection means.

6. The attention-attracting device according to claim 1, wherein the envelope is made of cloth or plastic film and is provided with one or both of a character and a picture which attracts attention.

7. The attention-attracting device according to claim 1 further includes one or a plurality of lamps attached to a middle frame which is provided in the middle of the plurality of telescopic poles.
